(19) United States
(12) Patent Application Publication
(10) Pub. No.: US 2002/0030777 A1
(43) Pub. Date: Mar. 14, 2002

(54) Liquid crystal device and liquid crystal

(76) Inventors: Koji Noguchi, Sagamihara-shi (JP); Mutsuo Mitsui, Hachiohji-shi (JP)

Correspondence Address: FITZPATRICK CELLA HARPER & SCINTO, 30 ROCKEFELLER PLAZA, NEW YORK, NY, 10112, US

(21) Appl. No.: 09/861,580

(22) Filed: May 22, 2001

(30) Foreign Application Priority Data
May 22, 2000 (JP) 150374/2000 (PAT.

(51) Int. Cl. G02F 1/1337

(52) U.S. Cl. 349/123

(57) ABSTRACT

A liquid crystal device exhibiting a high-speed responsiveness without requiring a voltage application treatment is formed of a pair of substrates each provided with an electrode for applying a voltage therebetween and a nematic liquid crystal disposed between the substrates. The pair of substrates are provided with mutually parallel uniaxial alignment directions and provided with asymmetrical alignment characteristics for achieving an asymmetrical bend alignment state of liquid crystal molecules giving mutually different pretilt angles with the substrates under no electric field.

### FIELD OF THE INVENTION AND RELATED ART

The present invention relates to a liquid crystal device and a liquid crystal display panel.

Hitherto, for alignment of nematic liquid crystals, there has been generally used a TN (twisted nematic) alignment device wherein a pair of substrates sandwiching therebetween a liquid crystal are rubbed in directions forming an angle of 90 deg. therebetween. It has been also known to use an ECB (electrically controlled birefringence)-mode device wherein a nematic liquid crystal is sandwiched between a pair of substrates rubbed in mutually anti-parallel directions and also a splay alignment device wherein a pair of substrates rubbed in identical directions are used.

Further, a type of cell (π-cell) wherein the above-mentioned liquid crystal placed in a splay alignment (as shown in FIG. 4A) is re-aligned into a bend alignment (FIG. 4B) by applying a voltage E thereto so as to provide an improved response speed, was disclosed by P. J. Bos, et al in 1983 (U.S. Pat. No. 4,582,396). Further, a system (OCB cell) as shown in FIG. 5 wherein such a bend alignment cell 54 is combined with phase compensators 52 and 53 for phase compensation together with first and second polarizers 51 and 55 to provide an improved viewing angle characteristic was disclosed by Uchida, et al., in 1992 (1993 Liquid Crystal Forum Preprint 2B13).

Such a bend alignment-type nematic liquid crystal device aims at superpressing a back-flow phenomenon in response of liquid crystal to provide improved and high-speed responsiveness. This mode of device involves a splay alignment state and is accompanied with a problem of requiring a very high voltage and a substantial time for transformation of the splay alignment into the bend alignment. Further, a continual voltage application is required for maintaining the bend alignment. Moreover, if a local failure in maintenance of the bend alignment occurs due to a fluctuation in aligning treatment condition over the liquid crystal panel, a problematic color irregularity more serious than spot defects in the TN-mode device is liable to occur due to the splay alignment state.

### SUMMARY OF THE INVENTION

A generic object of the present invention is to solve the above-mentioned problems of the prior art.

A more specific object of the present invention is to provide a liquid crystal device including a liquid crystal alignment state unnecessitating a pretreatment for realizing a bend alignment mode drive, and a liquid crystal display panel using the device.

According to the present invention, there is provided a liquid crystal device, comprising: a pair of substrates each provided with an electrode for applying a voltage therebetween and a nematic liquid crystal disposed between the substrates, wherein said pair of substrates are provided with mutually parallel uniaxial alignment directions and provided with asymmetrical alignment characteristics for achieving an asymmetrical bend alignment state of liquid crystal molecules giving mutually different pretilt angles with the substrates under no electric field.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic partial sectional view of an embodiment of the liquid crystal device according to the invention.

FIG. 2 is a schematic plan view of a liquid crystal display including a liquid crystal device of the invention and drive circuits therefor.

FIG. 3 is a partial schematic sectional view for one pixel of the liquid crystal device shown in FIG. 2.

FIGS. 4A and 4B are schematic sectional illustrations showing a splay alignment state and a bend alignment state, respectively, caused by transformation in a known liquid crystal device.

FIG. 5 illustrates a stacked structure including the liquid crystal shown in FIGS. 4A and 4B, polarizers and phase compensation plates for phase compensation of the liquid crystal device.

FIG. 6A and 6B illustrate an example of transformation between alignment states in a bend alignment cell.

FIGS. 7A and 7B illustrate an example of transformation between alignment states in an embodiment of the invention.

FIG. 8 is a graph showing a relationship between voltages and retardations.

FIG. 9 illustrates an optical system used for an example of the liquid crystal device of the invention.

FIG. 10 is a waveform diagram showing an example set of drive signal waveforms used for a liquid crystal device of Example 5.

FIG. 11 illustrates an alignment state in a liquid crystal device of Comparative Example 1.

### DETAILED DESCRIPTION OF THE INVENTION

The asymmetrical bend alignment state in the liquid crystal device of the present invention is characterized by the different pretilt angles at the boundaries with the two substrates and may alternatively be characterized by a position of substantially vertically aligned liquid crystal molecules biased from a middle point between the two substrates to one of the two substrates.

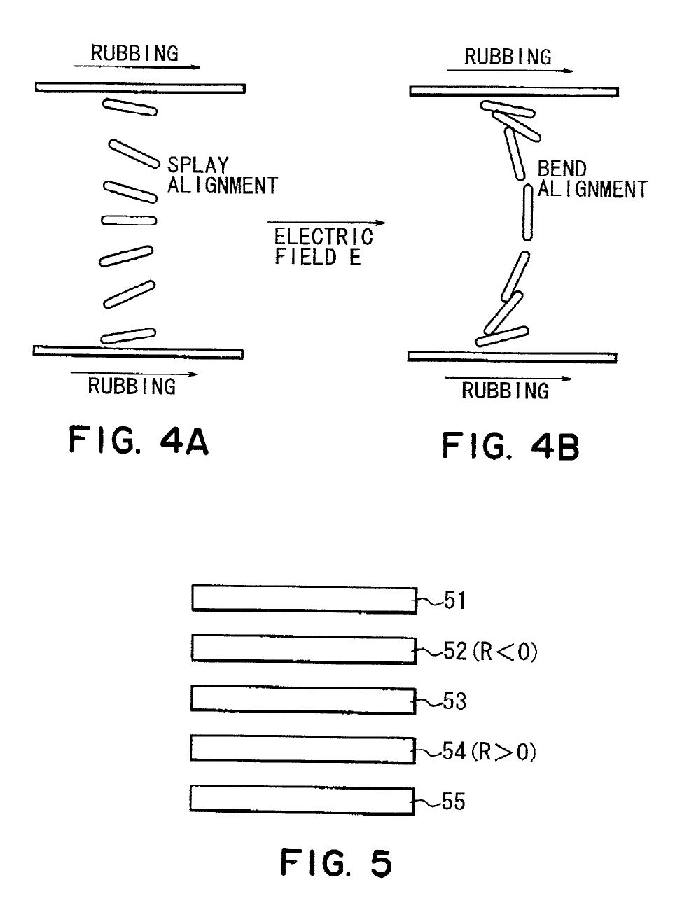

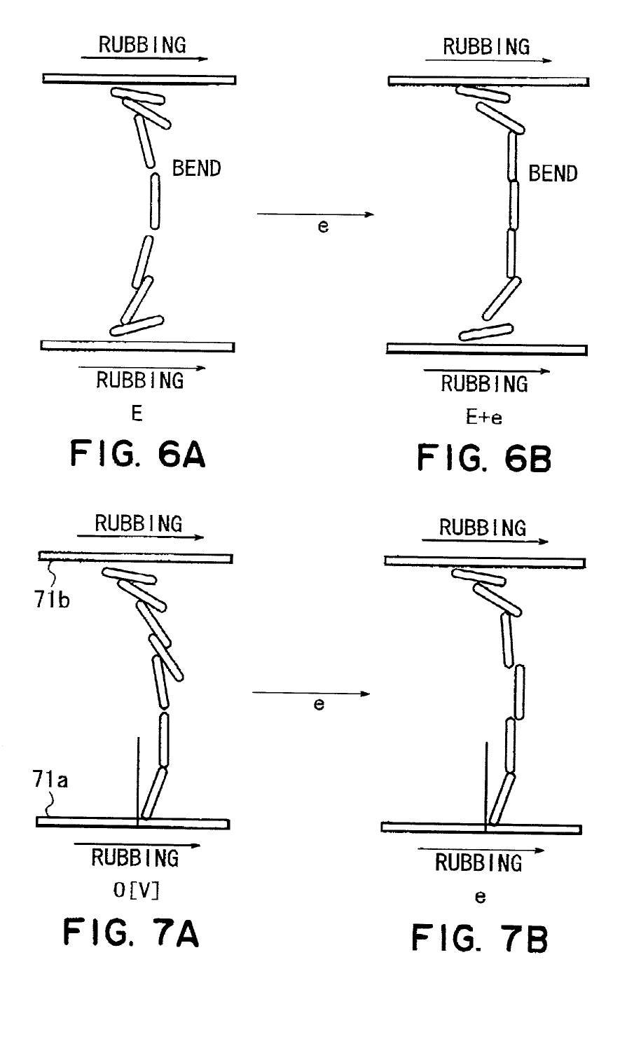

In an ordinary liquid crystal device (π-cell) utilizing a bend alignment state, a splay alignment state is stable under no voltage application (FIG. 4A) and is transformed into a symmetrical bend alignment state (FIG. 4B) under application of a high voltage. It has been reported that the switching in the bend alignment state exhibits a high-speed responsiveness between the bend alignment state shown in FIG. 6A (identical to the state shown in FIG. 4B) and a bend alignment state shown in FIG. 6B in response to application of an additional voltage e while being accompanied with little back-flow phenomenon caused by reverse twist liable to be caused in the TN-alignment mode.

The liquid crystal device of the present invention is characterized by an asymmetrical alignment state as shown in FIG. 7A wherein the liquid crystal molecules are placed in a bend alignment state showing a higher pretilt angle (close to 90 deg. in an example) with respect to one substrate 71a than the other substrate 71b under no voltage electric field. This state is switched to a more vertical alignment state shown in FIG. 7D under application of an electric field e with little backflow similarly as in the switching shown in FIGS. 6A and 6B Incidentally, if the pretilt angle with respect to the substrate 71a is gradually lowered until below a certain angle, the splay alignment shown in FIG. 4A becomes stabler so that it becomes necessary to establish the alignment state shown in FIG. 4A by electric field application. In the liquid crystal device of the present invention, the pretilt angle with respect to one substrate is set to be close to 0 deg. (but larger than 0 deg.) and the pretilt angle with respect to the other substrate is set to be sufficiently large as to stabilize not the splay alignment state but a quasi-bend alignment state as shown in FIG. 7A wherein a portion of liquid crystal molecules are aligned vertical to the substrates As a result, the quasi-bend alignment state (FIG. 7A) is realized without application of a bend alignment-forming voltage, and quick switching to a more vertical alignment state (FIG. 7B) is allowed without causing backflow. Moreover, the asymmetrical or quasi-bend alignment state (FIG. 7A) can be retained without application of any holding voltage.

More specifically, in order to realize the asymmetrical bend alignment state under no voltage application as shown in FIG. 7A, one substrate may preferably be provided with such a uniaxial alignment characteristic as to exhibit a pretilt angle which is larger than 0 deg, but close to 0 deg. This is preferred so as to retain as many liquid crystal molecules as possible which can exhibit a retardation between the substrates and cause a sufficient retardation change at a low voltage application. More specifically, as the pretilt angle with respect to one substrate is made close to 0 deg., the occurrence of fringes caused by fluctuation of pretilt angles along the substrate surface is suppressed. For this purpose, the pretilt angle may preferably be at most 10 deg., more preferably 1-5 deg., most preferably 2-5 deg.

As another condition for realizing the asymmetrical bend alignment state under no voltage application as shown in FIG. 7A, the other substrate may preferably be provided with such a uniaxial alignment characteristic as to exhibit a pretilt angle which is smaller than 90 deg. but close to 90 deg., more preferably in a range of from 30 to below 90 deg., most preferably 45-85 deg.

Such two substrates having asymmetrical alignment characteristics may be provided by forming a unidirectionally rubbed homogeneous alignment film on one substrate and forming a uniaxially rubbed homeotropic alignment film on the other substrate. As another method of providing the other substrate with a uniaxial alignment characteristic showing a high pretilt angle, it is possible to form an obliquely deposited alignment film capable of high pretilt angle alignment control on the other substrate.

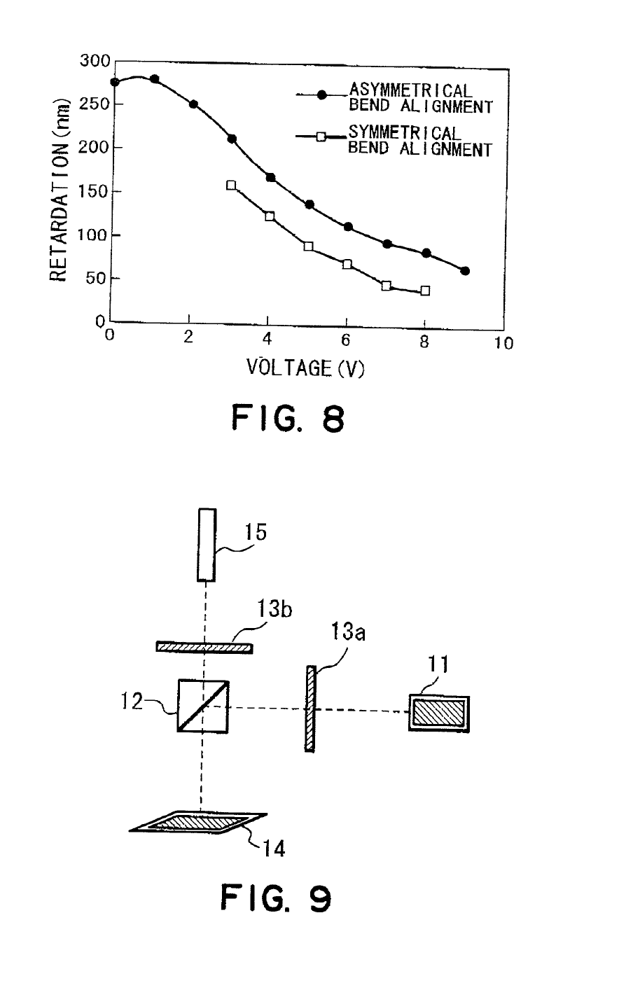

FIG. 8 is a graph showing a retardation change in response to an applied voltage obtained with respect a liquid crystal device (including an asymmetrical bend alignment state) according to an example of the present invention in parallel with a conventional π-call (including a symmetrical bend alignment state) each having a 3 μm-thick layer of nematic liquid crystal (“CF-1783”, made by Seimi Chemical K.K.) (i.e., liquid crystal device produced in similar manners as Example 1 and Comparative Example 2). As shown in FIG. 8, the liquid crystal device of the present invention exhibits a larger retardation change (e.g., 165 nm (=275−110) at 7 volts) than that (e.g., 70 nm (=120 nm (at 4 volts)−50 nm (at 7 volts)) of a conventional π-cell device. (Incidentally, a splay alignment state unsuitable for switching was developed at applied voltages below 4 volts.)

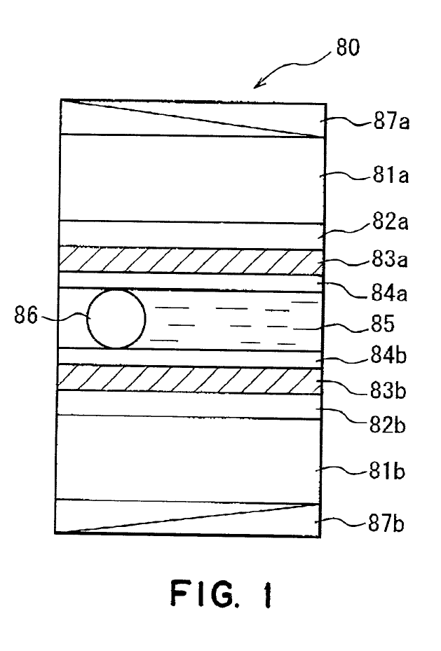

Now, the device structure of an embodiment of the liquid crystal device according to the present invention will be described more specifically with reference to FIG. 1

Referring to FIG. 1, a liquid crystal device 80 includes a cell structure sandwiched between a pair of cross-nicol polarizers 87a and 87b and formed by disposing a liquid crystal 85 between a pair of substrates 81a and 81b, which may be formed of transparent materials, such as glass, plastic, etc.

The substrates 81a and 81b are provided with electrodes 82a and 82b, respectively, of, e.g., In₂O₃ or ITO (indium tin oxide), for applying a voltage to the liquid crystal 85. As described in more detail later, one of the electrodes 82a and 82b may be arranged in the form of matrix dots each provided with a switching element, such as a TFT (thin film transistor) or a MIM (metal-insulator-metal) device, on one substrate, and the other of the electrodes 82a and 82b may be formed as a counter electrode in the form of a planar electrode or disposed in a prescribed pattern on the other substrate, so as to provide an active matrix structure.

The electrodes 82a and 82b may be coated, as desired, with insulating films 83a and 83b, respectively, of materials such as SiO₂, TiO₂ or Ta₂O₅, having a function of preventing short circuit between the electrodes.

Further, in contact with the liquid crystal 85, alignment control films 84a and 84b are disposed for establishing the asymmetrical bend alignment state of the liquid crystal 85 under no electric field according to the present invention. The alignment films 84a and 84b have uniaxial alignment characteristics parallel to each other and may be formed by unidirectionally rubbing a film of a polymeric material, such as polyimide or oblique vapor deposition of an inorganic material, such as SiO, SiOₓ or CaF₂. It is also possible to effect an optical alignment control.

The substrates 81a and 81b are disposed opposite to each other with a spacer 86 therebetween. Such a spacer 86 is used for determining a distance (cell gap) between the substrates 81a and 81b and may for example be formed of silica beads. The cell gap thus determined may preferably be set in the range of 1-10 μm depending on the liquid crystal material and the applied voltage.

One of the substrates 81a and 81b can be provided with color filters of R, G and E so as to form a color liquid crystal device. Alternatively, the liquid crystal device can be illuminated with light from light sources of R, G and B in time division to effect a full color display by color mixing.

The liquid crystal device may be formed as a transmission-type device wherein the substrates 81a and 81b are both formed of a transparent substrate and sandwiched between a pair of polarizers (87a and 87b, as shown in FIG. 1) for effecting optical modulation of light incident through one substrate to emit the modulated light through the other substrate. Alternatively, the liquid crystal device may be formed as a reflection-type device provided with a polarizer on at least one substrate wherein one of the substrates 81a and 81b is provided with a reflection plate, formed of a reflective material or provided with a member of a reflective material thereon for effecting optical modulation of light incident through one substrate to emit the modulated light through the same one substrate.

The liquid crystal device of the present invention may be provided with a drive circuit for supplying gradational signal voltages thereto to provide a liquid crystal display device capable of gradational display wherein the retardation values of the liquid crystal at respective pixels are continuously changed corresponding to alignment changes of the liquid crystal caused by the voltage application, thereby effecting a gradational display. For example, an analog gradational display may be performed by active matrix drive based on pulse amplitude modulation by using an active matrix substrate, equipped with TFTs as described above, as one substrate.

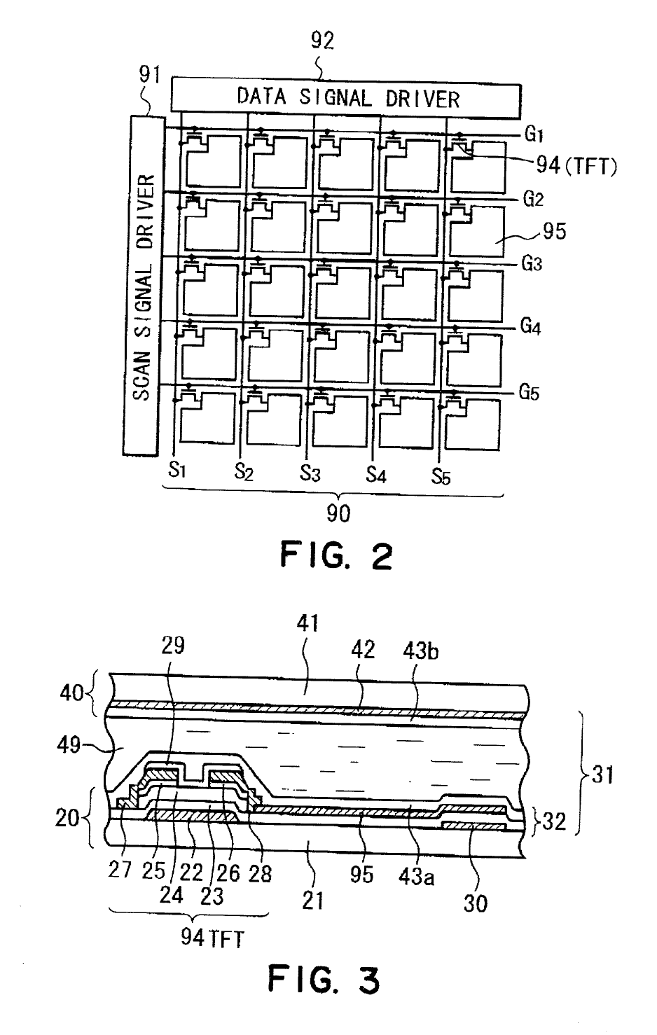

Now, such a liquid crystal device equipped with an active matrix substrate will be described with reference to FIGS. 2 and 3.

FIG. 2 is a schematic plan view of a liquid crystal display panel including a liquid crystal device of the present invention as represented by such an active matrix substrate (one substrate) and drive circuits therefor.

Referring to FIG. 2, a panel unit 90 corresponding to a liquid crystal device includes gate lines G1, G2, . . . extending horizontally (on the drawing) as scanning lines connected to a scanning signal driver 91 (as a drive means, and source lines S2, S2, . . . extending vertically (on the drawing) as data signal lines connected to a data signal driver 92 (as a drive means) so as intersect the gate lines G1, G2, . . . at right angles while being insulated from each other. At each intersection of the gate lines and the source lines, a thin film transistor (TFT) 94 as a switching device is disposed and a pixel electrode 95 is connected thereto to form a pixel together with a portion of the liquid crystal thereat. In FIG. 2, only 5×5 pixels are shown for convenience of illustration, but a much larger number of pixels are included in an ordinary panel. Incidentally, a MIM device can also be used instead of TFT.

The gate lines G1, G2, . . . are connected to gate electrodes of TFTs 94, the source lines S1, S2, . . . are connected to source electrodes of TFTs 94, and the pixel electrodes 95 are connected to drain electrodes of TFTs 94. In operation, the gate lines G2, G2, . . . selected, e.g., line-sequentially by the scanning signal driver 91 to supply a gate voltage to the gates of TFTs 94 on the selected gate line and in synchronism with the scanning selection of the gate line, data signal voltages corresponding to data to be written at respective pixels on the selected gate line are supplied to the source lines from the data signal driver 92 and applied via the associated TFTs to the respective pixel electrodes 95 on the selected gate line to write in the data to the corresponding pixels. The above operation is repeated for sequentially selected gate lines and associated pixels to write in prescribed data over the panel unit 90.

FIG. 3 is a cross-sectional view of one pixel portion 31 of the liquid crystal device (panel) 90 in FIG. 2. Referring to FIG. 3, a layer 49 of nematic liquid crystal is disposed between an active matrix substrate 20 equipped with a TFT 94 and a pixel electrode 95 and a counter electrode plate 40 having a common electrode 42 on a substrate 41 to provide a pixel 31 having a liquid crystal capacitance (C_{lc}).

In this embodiment, each TFT 94 formed on the active matrix substrate 20 comprises an amorphous Si-TFT. More specifically, each TFT is formed on a substrate 21 of, e.g., glass, and comprises a gate electrode 22 (connected to a gate line G1, G2, . . . in FIG. 2), a gate insulating film 23 of a material such as silicon nitride SiNₓ and an a-Si (amorphous Si) layer 24, which is further connected to a source electrode 27 and a drain electrode 28 separated from each other via n⁺ a-Si layers 25 and 26, respectively.

The source electrode 27 is connected to a source line (S1, S2, . . . shown in FIG. 2) and the drain electrode 28 is connected to a pixel electrode 95 which comprises a film of transparent conductor such as ITO. Further, a channel protection film 29 is disposed over the TFT 94 so as to coat the exposed portion of the a-Si layer 24. Each TFT 94 is turned on when the gate electrode 22 thereof is supplied with a gate pulse during a period of scanning selection of an associated gate line.

Further, on the active matrix substrate 20, each pixel is provided with a retention capacitance electrode 30 formed on the substrate 21 so as to form a structural portion 32 comprising a portion of the insulating film 23 (extended to cover the gate electrode 22) sandwiched between the retention capacitance electrode 30 and the pixel electrode 95, thereby providing a retention capacitance (Cs) in parallel with the liquid crystal capacitance (Clc).

The retention capacitance electrode 30 may generally be composed of a transparent conductor film, such as an ITO film, so as not to lower the aperture ratio of each pixel thereby.

The TFTs 94 and the pixel electrodes 95 on the active matrix substrate 20 are further coated with an alignment film 43a having a uniaxial alignment characteristic as by rubbing.

On the other hand, the counter electrode plate 40 is formed by coating a glass substrate 41 successively with a common electrode 42 having a uniform thickness over the entire area and an alignment film 43b having a uniaxial alignment characteristic.

In the device (panel) structure described with reference to FIGS. 2 and 3, it is also possible to use an active matrix substrate provided with polycrystalline silicon (p-Si) TFTs.

Further, in the case of forming a reflection-type display device, it is possible to use a reflective substrate comprising a single-crystalline silicon substrate in which active devices are formed.

The liquid crystal device structure described above of either a simple matrix type as shown in FIG. 1 or an active matrix type as shown in FIG. 3 may be stacked with or sandwiched between at least one polarizer. FIG. 5 shows an example of such a structure wherein a liquid crystal device 54 is sandwiched between a pair of polarizers 51 and 55 together with two phase compensators 52 and 53. As shown in FIG. 5, it is preferred to insert one or more compensators each comprising a film showing a retardation for providing a clearer “black” (or dark) display state.

The liquid crystal device of the present invention can also be used to constitute a projection type display system together with a projection optical system. In such a projection display system, the occurrence of the above-mentioned stripe texture liable to be caused by fluctuation in pretilt angle can be problematic and should preferably be minimized by providing a pretilt angle close to 0 deg. with respect to one substrate as mentioned above.

The present invention will be described more specifically based on Examples, which are however should not be construed as restricting the scope of the present invention.

### EXAMPLES

### Example 1 and Comparative Examples 1-2

Three liquid crystal devices including one device of Example and two devices of Comparative Examples were prepared in the following manner.

### Preparation of Cell 1

A homeotropic alignment film-forming solution (“JALS 2022”, made by JSR K.K.) was applied by spin coating on a glass substrate already provided with a patterned ITO electrode, pre-baked at 80° C. for 2 min and baked at 200° C. for 60 min. to form a 50 nm-thick alignment film, which was then subjected to rubbing with an 80 mm-dia. rubbing roller coated with a cotton fiber-planted cloth under the conditions of a roller rotation speed of 1000 rpm, a pressing depth of 0.5 mm and a substrate-feed speed of 50 mm/sec.

On the other hand, on a counter substrate provided with a reflection electrode, a homogeneous alignment film-forming solution (“SE-7992”, made by Nissan Kagaku K.K.) was applied by spin coating and baked at 200° C. for 60 min. to form a 50 nm-thick film, which was then subjected to rubbing with an 80 mm-dia. rubbing roller coated with a cotton fiber-planted cloth under the conditions of a roller rotation speed of 1000 rpm, a pressing depth of 0.7 mm and a substrate feed speed of 50 mm/sec.

The thus-treated two substrates (electrode plates) were applied to each other with 2.5 μm-dia. spacer beads dispersed and a sealing agent applied therebetween so that their rubbing directions were parallel to each other, thereby forming Cell 1 (blank cell).

### Preparation of Cell 2

A homeotropic alignment film-forming solution (“JALS 2022”, made by JSR K.K.) was applied by spin coating on a glass substrate already provided with a patterned ITO electrode, pre-baked at 80° C. for 2 min. and baked at 200° C. for 60 min. to form a 50 nm-thick alignment film, which was then subjected to rubbing with an 80 mm-dia. rubbing roller coated with a cotton fiber-planted cloth under the conditions of a roller rotation speed of 1000 rpm, a pressing depth of 0.5 mm and a substrate-feed speed of 50 mm/sec.

On the other hand, on a counter substrate provided with a reflection electrode, a homogeneous alignment film-forming solution (“SE-7992”, made by Nissan Kagaku K.K.) was applied by spin coating and baked at 200° C. for 60 min. to form a 50 nm-thick film, to provide a first treated substrate without rubbing.

On the other hand, on a counter substrate provided with a reflection electrode, a homogeneous alignment film-forming solution (“SE-7992”, made by Nissan Kagaku K.K.) was applied by spin coating and baked at 200° C. for 60 min. to form a 50 nm-thick film, which was then subjected to rubbing with an 80 mm-dia. rubbing roller coated with a cotton fiber-planted cloth under the conditions of a roller rotation speed of 1000 rpm, a pressing depth of 0.7 mm and a substrate feed speed of 50 mm/sec.

The thus-treated two substrates (electrode plates) were applied to each other with 2.0 μm-dia. spacer beads dispersed and a sealing agent applied therebetween, thereby forming Cell 2 (blank cell).

### Preparation of Cell 3

An ITO-provided substrate and a reflection electrode-provided substrate were respectively coated by spin coating with a homogeneous alignment film-forming Solution (“SE-7992”, made by Nissan Kagaku K.K.), followed by baking at 200° C. for 60 min. to form respectively 50 nm-thick films, which were then subjected to rubbing with an 80 nm-dia. rubbing roller coated with a cotton fiber-planted cloth under the conditions of a roller rotation speed of 1000 rpm, a pressing depth of 0.7 mm and a substrate feed speed of 50 mm/sec.).

The thus-treated two substrates (electrode plates) were applied to each other with 3.0 μm-dia. spacer beads dispersed and a sealing agent applied therebetween so that their rubbing direction were parallel to each other, thereby forming Cell 3 (blank cell).

Each of the above-prepared Cells 1-3 (blank cells) was filled with a nematic liquid crystal (“CF-1783”, made by Seimi Chemical K.K.) characterized by a large refractive index and a low viscosity allowing a high-speed drive at a low voltage.

Each of the liquid crystal-filled cells was stacked with two polycarbonate-made phase compensation plates so as to provide a normally white liquid crystal device 14 (shown in FIG. 9) of which “black” display state was compensated by the phase compensation plates. The liquid crystal device 14 was placed in an optical system shown in FIG. 9 including a light source 11, a beam splitter 12 cross nicol polarizers 13a and 13b, and a viewer 15. More specifically, the liquid crystal device 14 shown in FIG. 19 was formed by disposing a phase compensator between each filled liquid crystal cell and the beam splitter 12 so that the phase compensator had a retardation identical to that of the liquid crystal cell under voltage application (e.g., ca. 110 nm at 7 volts in FIG. 8) and was disposed to provide a slow phase axis forming an angle of 90 deg. with the uniaxial alignment axis of the liquid crystal cell. The beam splitter 12 was provided to provide a reflection type device with polarizers 13a and 13b arranged in cross nicols. Incidentally, in an ordinary white light reflection device, if the device was set to have a retardation of λ/4=560/4=140 nm with respect to a central wavelength (560 nm) in the visible region, the second polarizer 13b and the beam splitter 12 can be omitted.

Each liquid crystal device was driven by application of voltages in the range of 0-7 volts (3-7 volts for a device of Cell 3) and subjected to measurement of retardations and response time (tₒₙ for switching from white (T (transmittance)=100%) to black (T=10%) and doff for switching from black (T=0%) to white (T=90%) under application of 90 Hz rectangular waves.

The properties of each liquid crystal device at 90° C. are summarized in the following Table 1.

TABLE 1

| | Example | | |
|---|---|---|---|
| | 1 | Comp. 1 | Comp. 2 |
| Cell | 1 | 2 | 3 |
| Pretilt angles^{*1} (deg.) | | | |
| on ITO | 5 | 5 | 5 |
| on reflection electrode | 80 | 90 | 5 |
| Retardation change^{*2} (nm) | 135 | 140 | 100 |
| (0-7 volts) | | | |
| Retention voltage^{*3} | NR | NR | 3 |
| | | | volts |
| Pre-voltage application^{*3} | NR | NR | R |
| Response time (ms) | | | |
| tₒₙ | 0.5 | 0.6 | 0.2 |
| t_{off} | 0.9 | 3 | 0.7 |

^{*1}Values measured with respect to a eell prepared seperately with a pair of treated substrates concerned disposed with their uniaxial alighnment axes, if any, in anti-parrel directions. The retardation value of the cell thus prepared was measued, and the pretilt angle value was calculated from the manner retardation value, the Δn value of the liquid crystal used and the cell thickness.
^{*2}Difference between maximum and minimum

prepared separately with a pair of treated substrates concerned disposed with their uniaxial alignment axes, if any, in anti-parallel directions. The retardation value of the cell thus prepared was measured, and the pretilt angle value was calculated from the manner retardation value, the Δn value of the liquid crystal used and the cell thickness.

*2: Difference between maximum and minimum retardation values.

*3: NR represents “not required”.

R represents “required”.

To supplement the the results shown in Table 1, the device of Example 1 did not require the pre-voltage application (i.e., application of bend alignment-forming voltage) or a retention voltage for retaining the bend alignment state, but still exhibited a high response speed (short response time) comparable to that in the device (π-cell) of Comparative Example 2 (Cell 3). The device of Comparative Example 2 required application of high voltage of ca. 15 volts for ca. 20 min. for providing 1 cm² of a bend alignment state and a retention voltage of ca. 3 volts for retaining the resultant bend alignment state.

The device of Comparative Example 1 (using Cell 2) was a so-called HAN (hybrid aligned nematic) mode device, but compared with this device of Example 1 exhibited remarkably improved response speeds (shorter response time) presumably because of suppressed backflow due to a pretilt angle smaller than 90 deg. on one substrate.

### Examples 2 and 3

Cells 4 and 5 for examining pretilt angle-dependence were prepared by increasing the homeotropic alignment film thicknesses on the ITO-provided substrate to 5 nm and 10 nm, respectively, which were then subjected to the rubbing treatment at an identical rubbing intensity as adopted in Example 1. Cells 4 and 5 thus prepared were respectively filled with the same nematic liquid crystal (“CF-1783”) as in Example 1 to prepare liquid crystal devices of Examples 2 and 3.

Each of the devices of Examples 1-3 was observed through a polarizing microscope (at a magnification of 200) to evaluate the occurrence of stripe texture. The results are summarized in the following Table 2 together with separately measured pretilt angle values.

TABLE 2

| | Example | | |
|---|---|---|---|
| | 1 | 2 | 3 |
| Cell | 1 | 4 | 5 |
| Pretilt angles^{*1} (deg.) | | | |
| on ITO | 5 | 10 | 15 |
| on reflection electrode | 80 | 80 | 80 |
| Stripe texture | A | A | C |
| (0-7 volts) | | | |

The supplement the results show in Table 2, the device of Example 3 exhibited noticeable stripe texture in a completely “black” state (C) and the devices of Examples 1 and 2 exhibited-substantially no stripe texture (A).

### Example 4 and Comparative Example 3

Cells 6 and 7 (blank cells) were prepared following the procedures for the preparation of Cells 1 and 3, respectively, except that the counter substrates provided with reflection electrodes were changed to ITO-provided glass substrates, and the cell thicknesses were increased by using spacer beads of increased diameters. By using these Cells 6 and 7, transmission-type liquid crystal devices were prepared otherwise in similar manners as in Example 1.

The properties of the devices thus prepared at 25° C. are inclusively shown in Table 3 below as measured in the same manner as in Tables 1 and 2.

TABLE 3

Example

| | 4 | Comp. 3 |
|---|---|---|
| Cell | 6 | 7 |
| (similar to Cells) | (1) | (3) |
| Spacer dia. (μm) | 4 | 6 |
| Retardation change^{*2} (nm) | 200 | 200 |
| Retention voltage^{*3} | NR | 4 |
| | | volts |
| Pre-voltage application^{*3} | NR | R |
| Response time (ms) | | |
| tₒₙ | 0.9 | 1.0 |
| t_{off} | 2.1 | 2..0 |
| Stripe texture* | Al | B |

*The device of Comparative Example 3 exhibit stripe texture in halftone state (B).

Thus, the results were similarly to those obtained in the corresponding reflection type devices of Example 1 and Comparative Example 2.

The response time measured was almost two times that in the corresponding reflection-type device due to a corresponding decrease in field intensity.

### Example 5

A liquid crystal device equipped with switching devices was prepared and evaluated as follows.

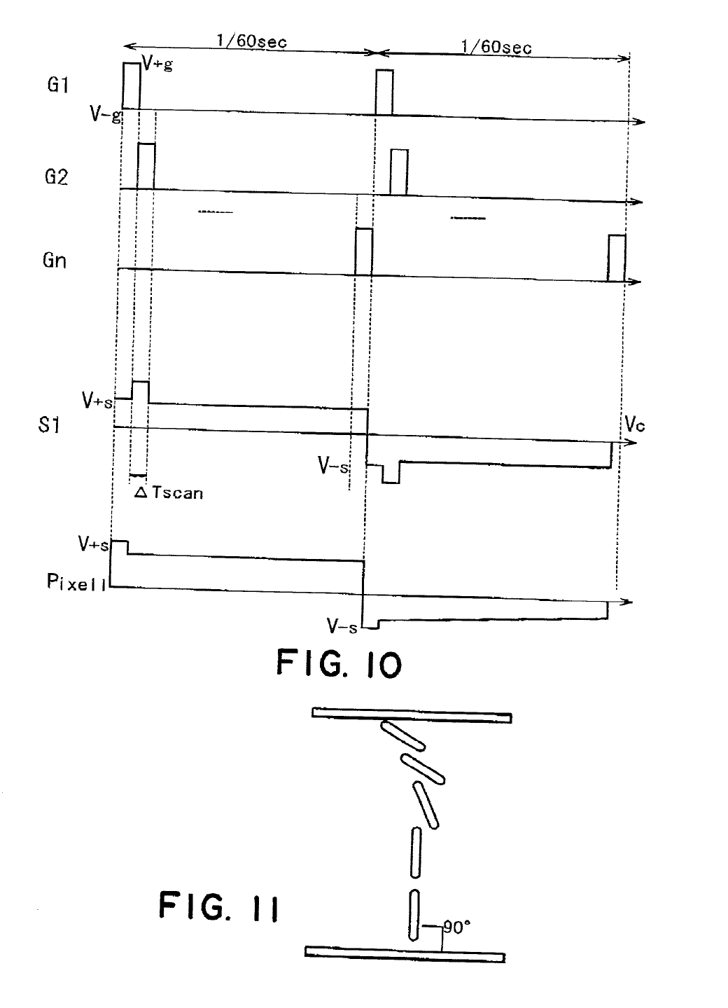

An active matrix substrate 20 having a structure and described with reference to FIG. 3 was prepared, and a cell structure was prepared therefrom in a manner similar as in preparation of Cell 6 for Example 4 except that the alignment film thereon was formed by printing. The liquid crystal device (panel) 90 thus prepared together with corresponding phase compensation plates was connected to a data signal driver 92 and a scanning signal driver (gate driver0 91 and driver for display application of time-serial waveforms as shown in FIG. 10.

As a result, the liquid crystal device does not require a pre-aligning voltage application but exhibited a high-speed responsiveness similarly as the device of Example 4.

As described above, according to the present invention, a liquid crystal device (or display panel) exhibiting a high-speed responsiveness without requiring a pre-aligning treatment is provided by using a pair of substrates subjected to treatments for providing specifically different alignment states.

What is claimed is:

1. A liquid crystal devices comprising: a pair of substrates each provided with an electrode for applying a voltage therebetween and a nematic liquid crystal disposed between the substrates, wherein said pair of substrates are provided with mutually parallel uniaxial alignment directions and provided with asymmetrical alignment characteristics for achieving an asymmetrical bend alignment state of liquid crystal molecules giving mutually different pretilt angles with the substrates under no electric field

2. A liquid crystal device according to claim 1, wherein one substrate provides a pretilt angle of liquid crystal molecules which is larger than 0 deg. and at most 10 deg.

3. A liquid crystal device according to claim 1, wherein the pair of substrates are provided with different species of aligning control layers for providing the mutually different pretilt angles.

4. A liquid crystal device according to claim 1, further comprising a phase compensator for displaying a black display state.

5. A liquid crystal device according to claim 1, further including a switching device for applying a drive voltage to the liquid crystal.

6. A liquid crystal device according to claim 1, wherein at least one of the substrates is provided with a rubbed polymeric alignment film exhibiting a uniaxial alignment characteristic.

7. A liquid crystal device according to claim 1, wherein at least one of the substrates is provided with a uniaxial alignment film formed by oblique vapor deposition.

8. A liquid crystal device according to claim 1, wherein one substrate is provided with a reflection electrode to provide a reflection-type liquid crystal device

9. A liquid crystal display panel, comprising: a liquid crystal device according to any one of claims 1 to 8, and drive means therefor.
